(19) United States
(12) Patent Application Publication
(10) Pub. No.: US 2010/0333175 A1
(43) Pub. Date: Dec. 30, 2010

(54) Smart Net System and Method of Use

(75) Inventors: Dail Robert Cox, Boise, ID (US); Justin Del Cox, Boise, ID (US)

Correspondence Address: Auto Electronica Inc.;Dail Robert Cox, CEO, 2399 S. Orchard, Boise, ID, 83705, US

(73) Assignee: Auto Electronica Inc, Boise, ID (US)

(21) Appl. No.: 12/822,282

(22) Filed: Jun. 24, 2010

Related U.S. Application Data
(60) Provisional application No. 61/219,767, filed on Jun. 24, 2009.

(51) Int. Cl. G06F 13/12; G06F 12/00; G06F 21/20; G06F 15/16; G09B 7/00

(52) U.S. Cl. 726/3; 710/73; 711/115; 709/204; 704/246; 704/235; 434/350; 704/E15.043

(57) ABSTRACT

The smart net system has a smart net controller and one or more computers each with a smart net key. The smart net keys spawn a smart window on each computer and communicate wirelessly with the smart net controller. Via the smart net key, computer users can transmit presentations to a video display or projector attached to the smart net controller and/or communicates with other electronic devices connected to the smart net system. Data such as files, presentations, or instant messages can be shared among users by way of the smart window. The need for sharing a video cable or a computer or printing up handouts for distribution is reduced or eliminated. The efficiency of conferences, lectures, classes and workgroups is increased. Smart net for the small office provides network like communications without the traditional networking hardware allowing communications between computers without allowing computers access to each other's information.

The terminology “computer network” refers to more than one computer that is connected together usually by a router or server or by wiring. This almost always requires configuring the connected computers many times done using “shares” or defining the locations accessible to other computers on the computer network.

The terms “smart net computer” and “smart net controller” are used as interchangeable terms as computing systems may have integrated or separate controller functions depending upon the nature of the circuitry.

The terms smart window and smart net window are used interchangeably.

The smart net computing network does not connect one computer to another in the traditional context of a router or server or by defining accessible locations. Computers connected to the smart net computing network do not communicate with each other directly but they can communicate with the smart net computer allowing data to be shared between connected computers by way of the smart net computer and the smart net window.

The term “T&R” stands for transmit and receive.

The smart key example is used extensively in the patents an example to illustrate one of multiple ways to interface between the smart mouse and any computer(s). The smart key is just a single method of connectivity. Wire and/or wireless communications of many natures can be utilized and the smart key is not a requirement for connectivity but is used as an example to illustrate the concept of networking without traditional kinds of router or server methods.

The term “connected computer” means the computer is connected to the smart net computer or multiple computers that connect only by way of the smart net computer. This is not to be confused with computers connecting to each other by a router or other type of connection

### FIELD OF THE INVENTION

The present invention relates to the field of collaborative computing, and in particular to ad hoc computer associations in temporary conference, lecture classroom, or gaming situations.

### BACKGROUND

Portable computers are very common in conference meetings today. In many occasions several people sit around a conference table and pass around a video cable connected to a video projector. Often considerable time is wasted while the video cable is reconnected and the computer owner fusses with the computer settings to enable the computer external video port to drive the projector. A game of musical chairs often ensues as conference participants rearrange their seating to allow access to a short video cable. In the worst case, electrostatic discharge (ESD) can disrupt or even damage equipment like computers or video projectors. Additionally, bent video connector pins can halt a presentation when presenters attempt to switch a video cable between computers. When this happens, what should be productive time degrades into an impromptu debugging session by amateurs.

In larger forums like classrooms, presenters must trade off the podium with classmates during speaker changes. Alternatives include using one designated computer driving one video projector. In this case the presenters send their presentation ahead of time by email, compact disk, or memory module. This send-the-data-ahead approach creates a new set of problems. The new problems include incompatible versions of software, incompatible brands of computers, different operating systems. Additionally, the all too common last minute addition to a presentation is frustrated.

Another current method to source numerous presentations in a common forum is to use a wireless network. In addition to many of the problems listed above comes the problem of network configuration and security. Questions such as; “Is the network secure?”, “Is the share group or workgroup configured correctly?” “Will viruses or other malware from other presenters infect my computer?”

Not only conferences in a business setting require safe access to the video projector or other common assets. Increasingly, schools from college to high school to junior high even down to grade school are using portable computers in individual presentations or collaborative projects. It is important that valuable class time is not wasted in the set-up of a temporary network. Additionally, the teacher or class moderator needs to maintain control of the shared resource both for discipline and orchestration of the lesson plan.

In many conference, seminar or classroom situations there is the problem of handouts. The presenter may announce a website where the presentation material may be found. Other approaches include the pass-around clip board where interested recipients list their email addresses to receive a copy of the presentation. Still other methods include the give-me-your-business-card announcement. Such approaches create more work for the presenters and introduce more error prone steps in the process. Even if each presenter came loaded with a set of preprinted handouts there is the problem of wasting paper, transportation and shipping of handouts, and the all too frequent problem of not having enough handouts.

### SUMMARY

The smart net system enables the sharing of data among multiple computers in a setting such as conference, lecture, office or classroom. The smart net system has a smart net controller and multiple smart net keys. The smart net controller includes a processor, memory, wireless I/O system and various types of ports. The ports can include but are not limited to, a telephone interface, network port, Bluetooth interfaces, video output, USB ports, biometric readers, audio inputs/outputs, and user interfaces. Each smart net key attaches or plugs into one of many portable computers. Each smart net key has an I/O system in communication with the I/O system of the smart net controller; and software configured to establish a smart net window on the associated computer.

The smart net key plugs into a computer by an interface such as a USB port. In operation, the smart net key spawns a smart net window on the computer. A user can copy data such as files, applications or presentations to the smart net window from other areas of the computer's desktop. Once transferred to the smart net window, the smart net key together with the smart net window will transfer the data to the smart net controller over the wireless I/O system established between the smart net controller and the smart net key. The smart net controller can then display this data via an attached video projector for use in a conference type setting. The smart net controller can also send the data to other computers via their attached smart keys. Other computers receiving the data transmitted by the smart net controller display the data in their smart net windows. The users of the other computers can copy the data from the smart net window to other applications or storage on the individual computers.

By copying data from other areas of the desktop to the smart net window, the user of each computer can share data with other computers connected via the smart net system. Additionally, the users can chose which of the computers will display data in the computer's smart net window via the video projector attached to the smart net controller.

The smart net system eliminates the need for multiple computer users to disconnect and reconnect a video cable. This reduces the risk of individual computers to ESD damage or damage to pins due to switching a video cable among computers. Since the wireless connection is between the smart net controller and each smart net key, the need for a traditional network and its associated configuration needs are reduced. In conference settings where several presenters are present, the active access to the video projector can be passed by mutual consent or through the control of a moderator. This action saves time as no changing of a video cable is needed. Also because each presenter is presenting from their own computer, the need to send presentation material ahead is reduced. Each presenter can edit their individual material even during the presentation if necessary.

Because computers are fed a data stream from the smart net controller, the risk of virus infections from a common network is also reduced. Since each computer can receive a copy of the data in the presentation in its smart net window, a user can chose to copy the data to their computer, thus reducing the need for handouts.

The examples given to Smart Net and Smart Key have multiple implementations that one versed in the art will understand and should not limit the application of the concept. Communications using wire devices and wireless devices of multiple technologies, i.e. Bluetooth, WiFi etc. illustrate several of many alternative implementations of Smart Net and Smart Key. Indeed the Smart Key itself may not even be required in the implementation nor should this document be construed to be limited to the computer itself as a means for communication within the Smart Net environment. Hand held devices like cell phones, blackberry communications of even a mouse with intelligence as illustrated in complimentary patent pending material could be substituted into the concept of the Smart Net.

### BRIEF DESCRIPTION OF THE DRAWINGS

The summary above and the following detailed description will be better understood in view of the enclosed figures which depict details of various embodiments. It should however be noted that the invention is not limited to the precise arrangement shown in the drawings and that the drawings are provided merely as examples.

FIG. 1 shows one embodiment of the smart net controller.

FIG. 2 shows one embodiment of a smart net key.

FIG. 3 shows an exemplary system of the smart net controller and smart net keys installed in computers.

FIG. 4 shows one embodiment of a smart network window.

FIGS. 5-10 show one embodiment of a method of using the smart net system to transfer files in a conference or classroom environment.

FIG. 11 shows a flow chart of one embodiment of a method of using the smart net system to transfer files.

FIGS. 12-15 show one embodiment of a method of using the smart net system to display a running application in a conference or classroom environment.

FIG. 16 shows flow chart of one embodiment of a method of using the smart net system to display a running application.

### DETAILED DESCRIPTION

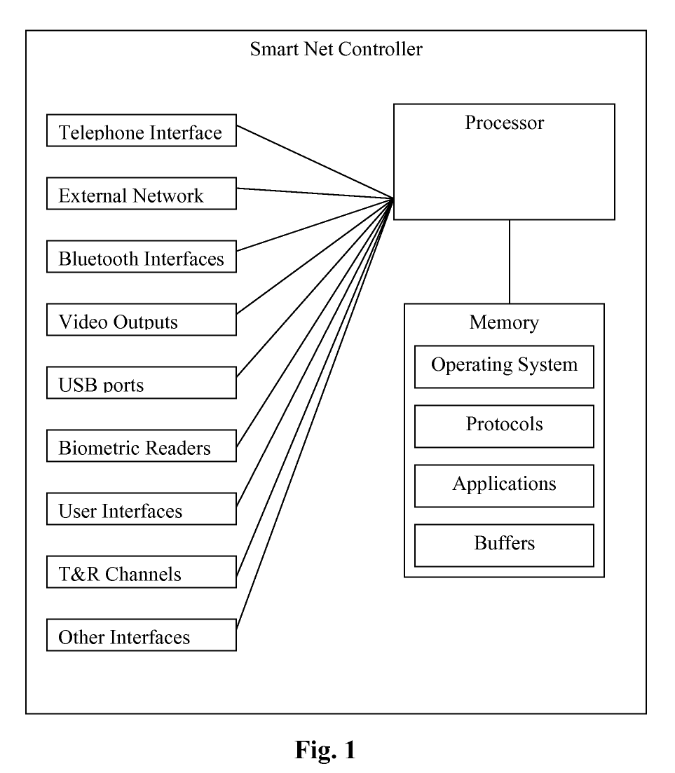

FIG. 1 shows one embodiment of the smart net controller. The smart net controller has a processor and associated support circuitry. The memory can be any combination of rotating memory or semiconductor memory such as non-volatile, or volatile. Other memory types are also possible. The memory holds data common to typical computer systems including, but not limited to, an operating system, application software, device drivers, protocols, and general purpose buffers and data storage. The smart net controller can have any combination of I/O devices for example, a telephone interface for voice or data, connections to an external network such as an internet connection, Bluetooth, video interfaces for driving a video projector or video display, USB ports for additional memory or devices, biometric readers for security, user interfaces such as a mouse or keyboard, a wireless I/O system shown in FIG. 1 as T&R (transmit and receive) channels) as well as other interfaces.

In operation the smart net controller of FIG. 1 communicates with the many portable computers via the smart net key. Both the smart net controller and the smart net key use the I/O channels shown as T&R channels, to send data bi-directionally from the smart net controller to the smart net key and associated computer or from a computer via the smart net key to the smart net controller.

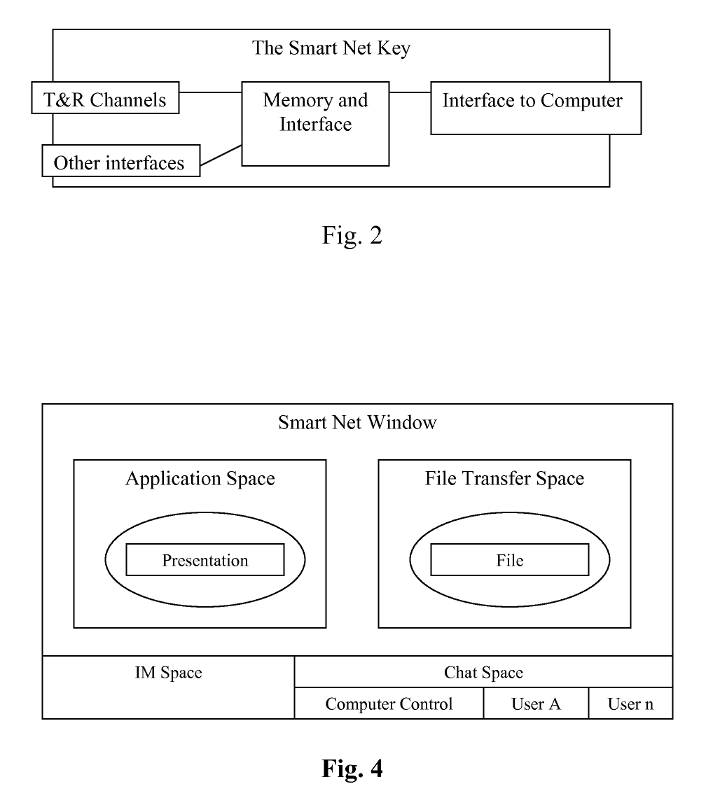

FIG. 2 depicts one embodiment of a smart net key. The smart net key has a controller or processor and associated memory. The smart key communicates with the smart net controller using the T&R channels which form the wireless I/O. The interface to the computer can be any type of commonly used interface such as USB. Additional user interfaces are possible. One example of another interface is an audio I/O port for use in conference type situations. This feature is useful in large lecture halls to eliminate the pass-around-the-microphone problem, or in meetings that are separated geographically. The memory of the smart net key holds application software such as that needed to spawn the smart net window.

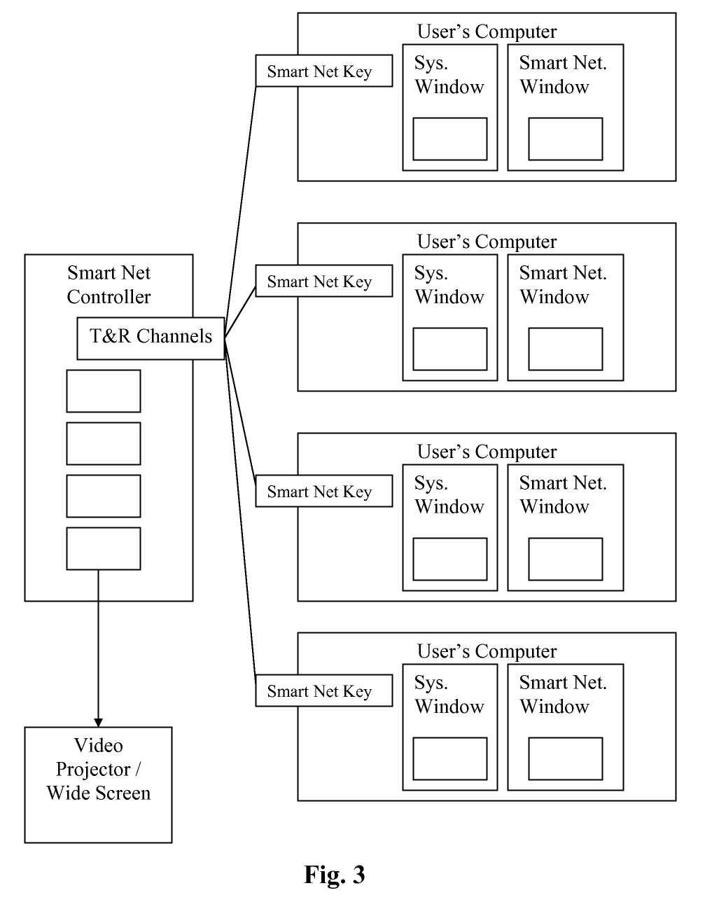

FIG. 3 shows the smart net system in one possible application. In FIG. 3 four computers each have a smart net key installed. Each computer by virtue of its installed smart net key is in communication with the smart net controller. The smart net controller drives a video projector. This is a common conference room or classroom scene where each of the participants is able to present information using the video projector. Each computer further has one or more application windows referred to in FIG. 3 as a “Sys. Window”. Because of the smart net key, each computer has a smart net window. The smart net window is discussed in conjunction with FIG. 4.

FIG. 4 shows one embodiment of the smart net window. The smart net window is spawned in every computer which has a smart key installed. Several types of spaces exist in the smart net window. The application space holds a running application that can be displayed on the video projector attached to the smart net controller of FIG. 3. The file transfer space holds files that are transferred from one computer to another using the smart net system. The IM (instant messaging) space and chart space allow smart net users to share text notes among themselves. The computer control selects which user is controlling the video projector attached to the smart net controller.

In operation the users can agree to share access to the video projector among themselves using the computer control block of FIG. 4. In other embodiments such as a classroom, a single moderator such as a teacher may have control of the application space and therefore the video projector as well as the file transfer space and other spaces within the smart net window. Moderators can at their discretion, give various presenters access to the video projector. A computer user can have a program running in their smart net window's application space at any time. If the video control is passed to them, the video projector displays the program running in their computer's application space for all to see. If some time before, during or after the presentation, a user wants to share files such as handouts, or other notes, the user can copy files from their computer into the file transfer space. The smart net system makes files in the file transfer space available to all users. The IM and chat space allow users to share notes. In some situations such as a classroom, the IM, chat, and file transfer features may be turned off.

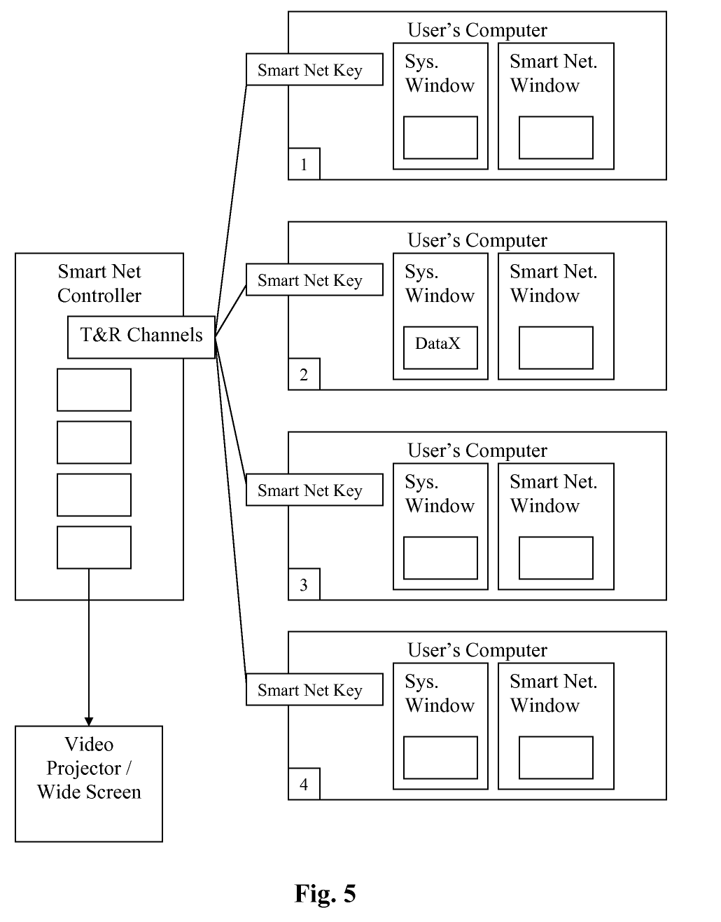

FIGS. 5 though 10 show one embodiment of the smart net system in use. The Figs. represent a progression of file sharing in a conference or classroom use of the smart net system. Four users, each with a smart net key enabled computer are sitting in a conference or classroom. The smart net controller is in communication with all the computers and connects to a video projector.

In FIG. 5 the computers are numbered 1, 2, 3, and 4. Each of the computers has a smart net window which was spawned by the software on the smart net key. Other application windows, labeled “Sys. Window” in the figures are also present on each computer. The “Sys.” or system windows represent windows associated with other programs on the computers. Example applications could be a word processor window, a slide presentation window or a display of the computer's file structure. In FIG. 5 computer 2 has a system window open with some type of file in it named “DataX”. The information stored in DataX can be any type of data that the user of computer 2 wishes to share with the other users connected to the smart net system.

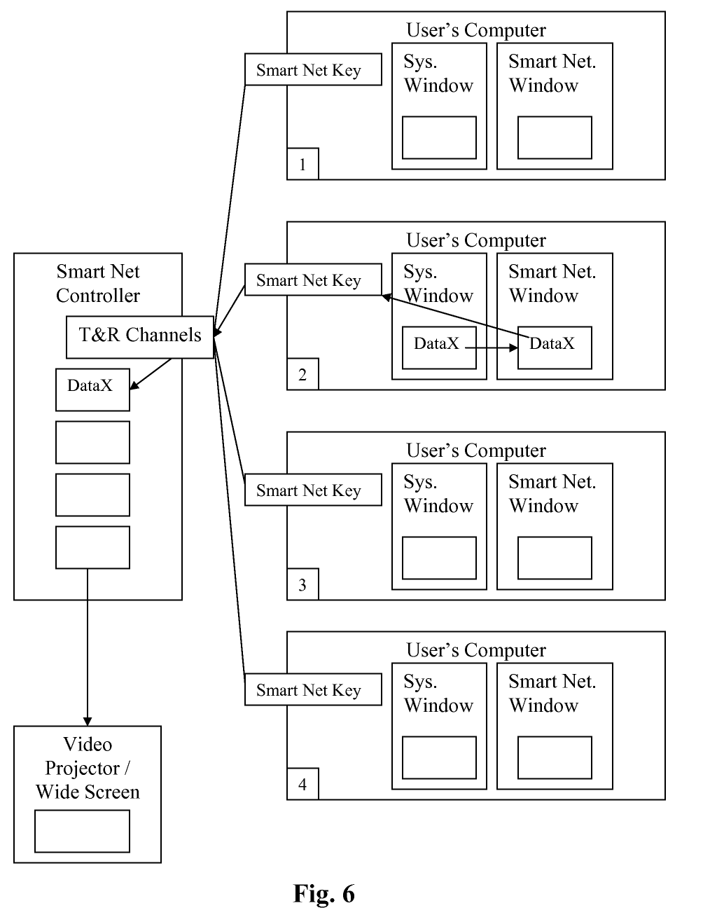

In FIG. 6 the user of computer 2 copies the contents of the system window into the smart net file transfer space. Many copy methods are possible such as copy and paste or drag and drop. This action is indicated by the arrow directed from the system window to the smart net window. This action causes the data, labeled “DataX” in the smart net window to be transmitted to the smart net controller. Arrows indicate the path of DataX transmitted from computer 2 to the smart net controller. The path starts at the smart net window of computer 2 through the smart net key of computer 2 to the T&R channels of the smart net controller, into the memory of the smart net controller. Note that no physical media or traditional computer network is needed.

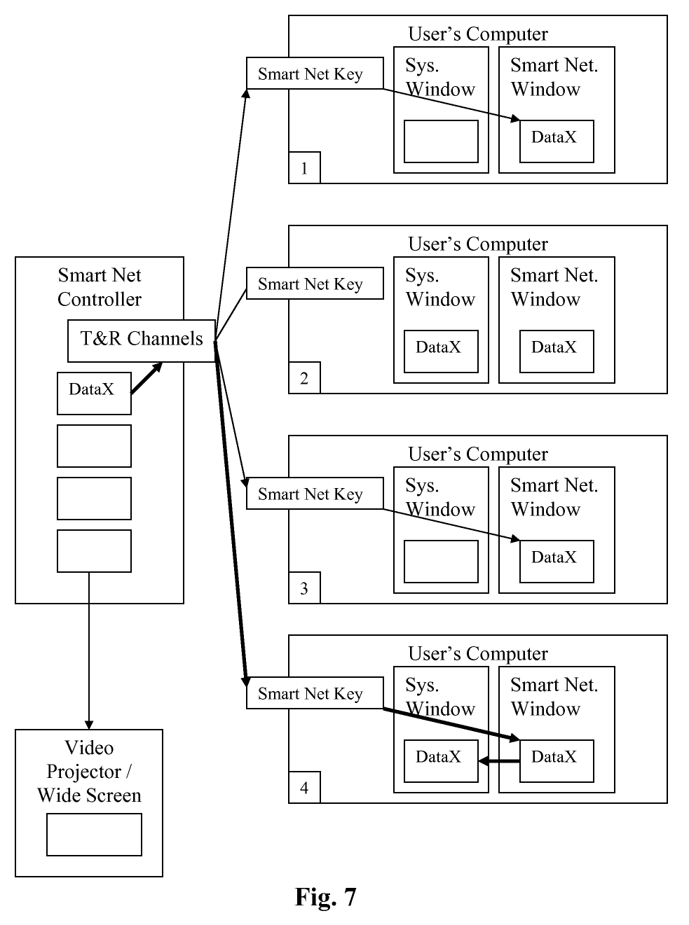

In FIG. 7 the data, DataX, originally from computer 2 is now on the smart net controller. An icon or some other representation of DataX now appears in the smart net window of each computer. If enabled, the smart net controller can transmit DataX to computers 1, 3 and 4 through the T&R Channels and smart net keys. Users can view the data in the smart net file transfer space on their own computer. The user of computer 4 decides to make a copy of DataX. This is indicated in FIG. 7 by the heavy arrow from the smart net controller to the file transfer space of computer 4, to an application window on computer 4. This transfer of DataX from the computer 4 smart net window to an application window is an example of how files can easily be shared among users. Such transfers allow for easy and rapid distribution of data and handouts even during a presentation. Note that the disruption of handing out printed material, taking down email addresses, or even assembling a distribution list is unnecessary. The user of each computer can take or leave the data as they choose.

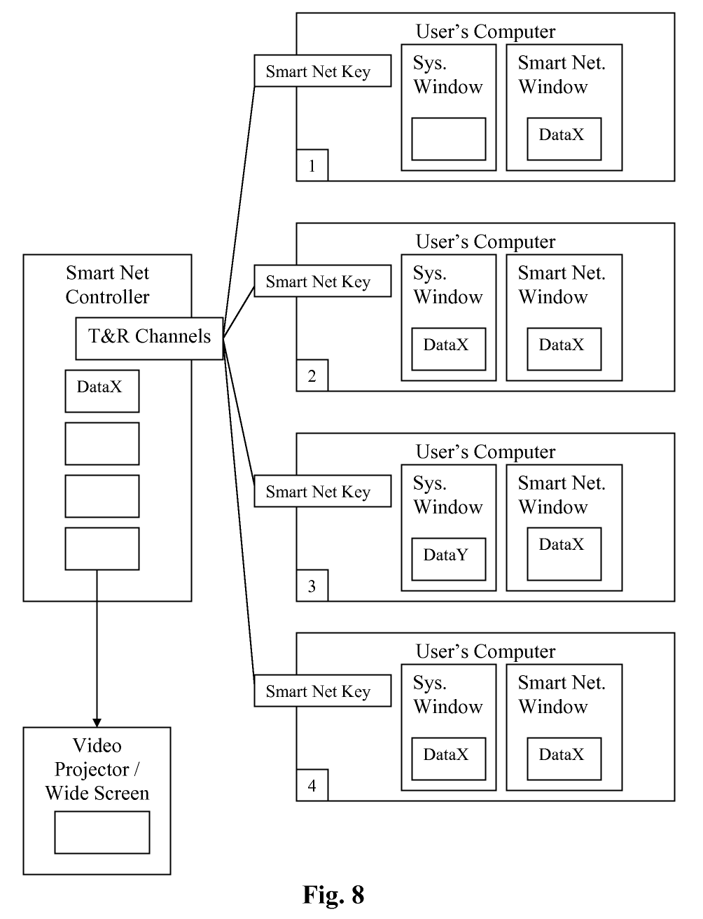

In FIG. 8 the user of computer 3 has a file named “DataY”. The user of computer 3 wishes to share this file with others in the group. DataX from the user of computer 2 is still available to all.

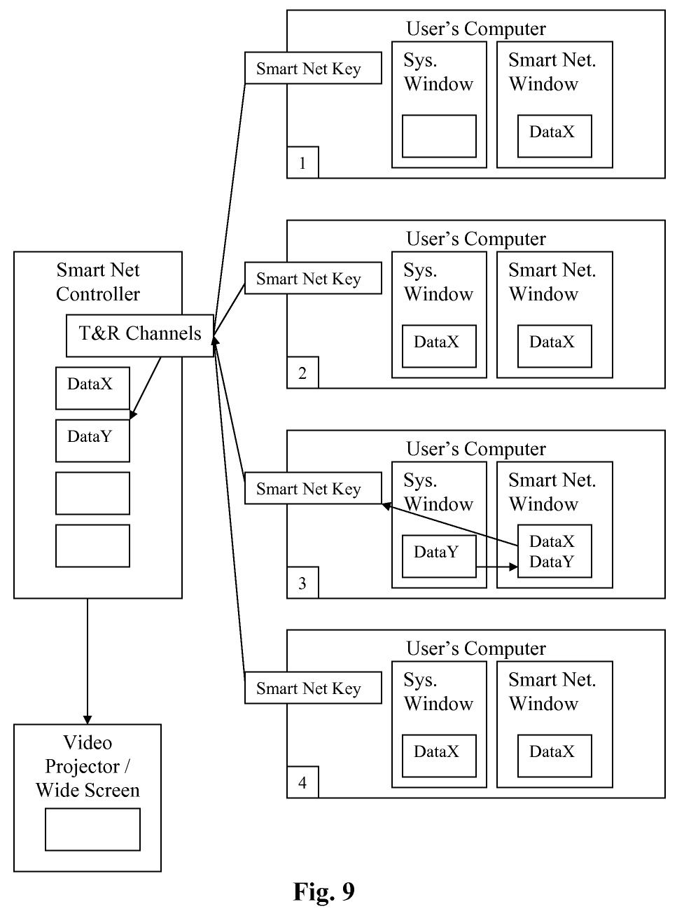

In FIG. 9 the user of computer 3 moves DataY from the system window to the smart net file transfer space. Once the DataY is moved to the smart net file transfer space of computer 3 a chain of events, similar to those of FIG. 6 takes place. The result is that DataY is now on the smart net controller.

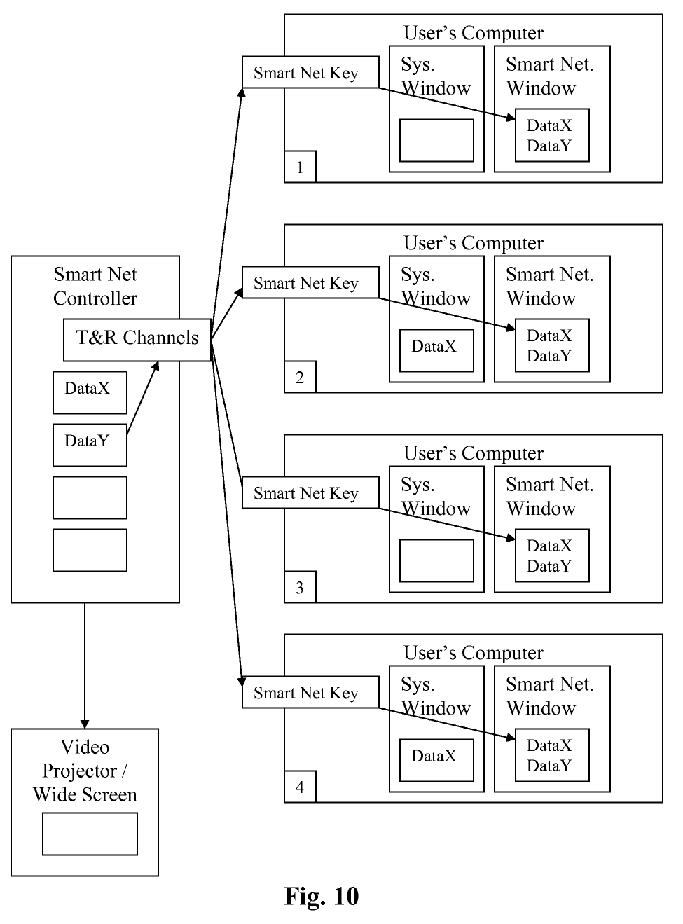

The events of FIG. 10 are analogous to those of FIG. 7 except now DataY is made available to the other computers via the smart net system. Additionally as depicted in FIG. 3 files, instant messages and chat can be exchanged among users without the need to first display them on the video projector.

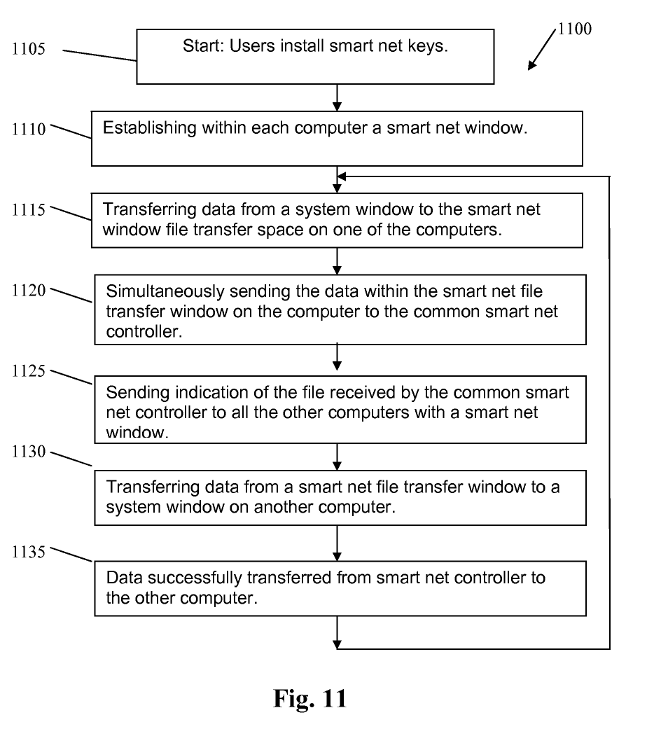

FIG. 11 summarizes the events of a typical file transfer via the smart net system in flow chart 1100. At 1105 each user installs a smart net key into their computer. Block 1110 establishes a smart net window in each computer by way of the software on the smart net key or smart net controller. In block 1115 a user of one computer transfers a file from a system window to the smart net file transfer space. At 1120 the smart net system simultaneously sends the data from the computer to the smart net controller via the smart net key and the T&R channels of the smart net controller. At 1125, the smart net controller sends an icon or other indication of the received file to the other computers via the T&R channels and the smart net keys of each computer. At 1130, individual users can decide whether or not to transfer data from their smart net window to a system window on their computer. At 1135 the loop from block 1135 to block 1115 illustrates that multiple users can transfer files or other data among themselves as the meeting, conference or class progresses.

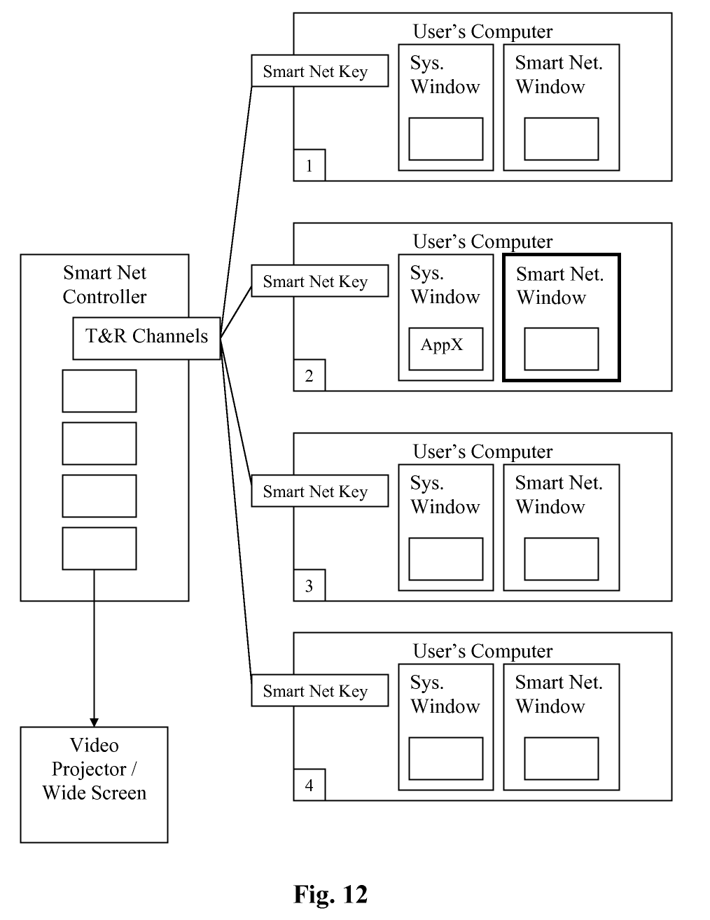

While FIGS. 5 though 10 show file transfer among computers, FIGS. 12-15 show a presentation shared by one computer at a time on the overhead projector or other type of display. The FIGS. 12-15 represent a progression of a conference or classroom use of the smart net system. Four users, each with a smart net key enabled computer are sitting in a conference or classroom. The smart net controller is in communication with all the computers and connects to a video projector.

In FIG. 12 the computers are numbered 1, 2, 3, and 4. Each of the computers has a smart net window which was spawned by the software on the smart net key. Other application windows, labeled “Sys. Window” in the figures are also present on each computer. The “Sys.” or system windows represent windows associated with other programs on the computers. Example applications could be a word processor window, a slide presentation window or a display of the computer's file structure. In FIG. 12, the smart net window on computer 2 is highlighted indicating that computer 2 drives the video projector attached to the smart net controller. Computer 2 drives the video projector via the application space within the smart net window. The mechanism for deciding which computer drives the video projector can be by mutual agreement with users sharing the video projector or one of the computers or smart net controller itself can be designated as the moderator. In such case, the moderator alone controls which computer drives the video projector. In FIG. 12 computer 2 has a system window open with an application such as a slide presentation like Windows Power Point. The system window shows “AppX” indicating some type of application program running in the system window.

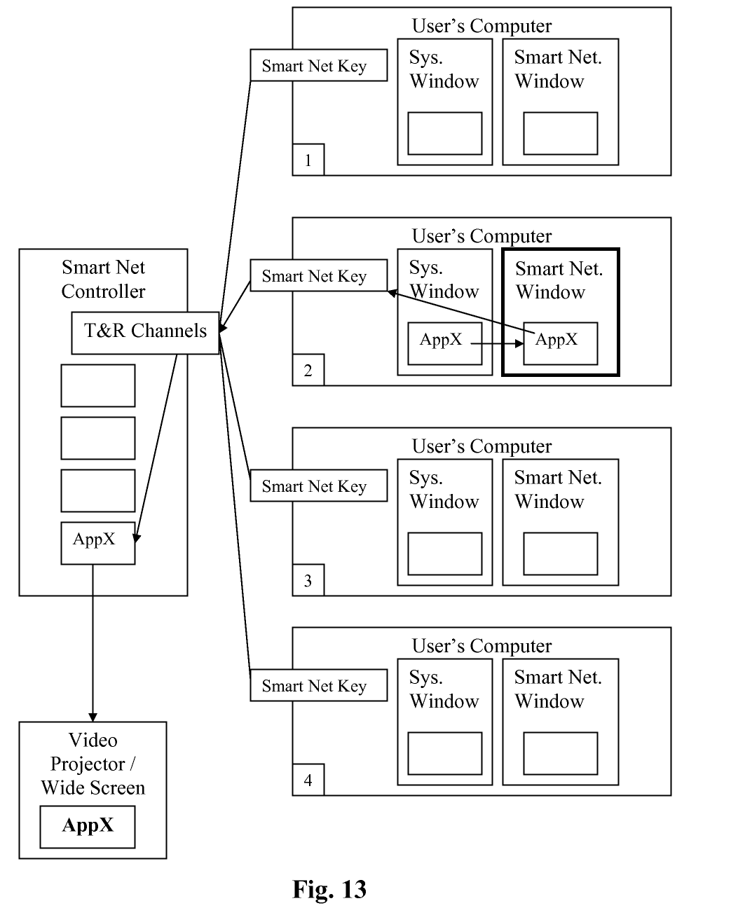

In FIG. 13 the user of computer 2 copies the contents of the system window into the smart net application space window. The copy function of the application into the smart net window application space can be accomplished in a number of ways. Two of the ways include dragging an icon of the running application into the application space while another is to launch the application in the application space directly. This action is indicated by the arrow directed from the system window to the smart net application window. This action causes the presentation, labeled “AppX” in the smart net window to be ultimately displayed on the video projector. Arrows indicate the path of AppX transmitted from computer 2 to the video projector. The path starts at the smart net window application space of computer 2 through the smart net key of computer 2 to the T&R channels of the smart net controller, into the memory of the smart net controller and finally to the video projector. At this point all the viewers of the video projector can see AppX as displayed on computer 2. This action allows the user of computer 2 to be the presenter and use the video projector. Note that the change of a video cable between computers was not needed.

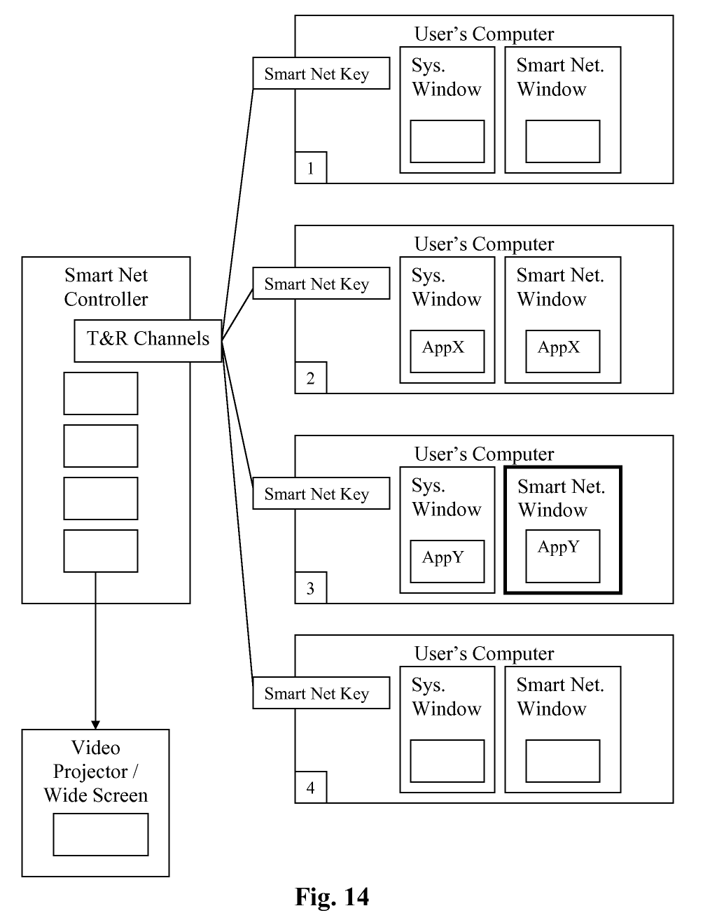

In FIG. 14 the control of the video projector has passed from the user of computer 2 to the user of computer 3. This is indicated by the highlighted smart net window moving from computer 2 to computer 3. As described previously, the decision of who controls the video projector can be by mutual consent or by the action of a moderator who has control. In FIG. 14 the user of computer 3 has a presentation ready in the smart net window application space. This presentation is labeled “AppY”. The user of computer 3 is prepared to display it to the other members of the group.

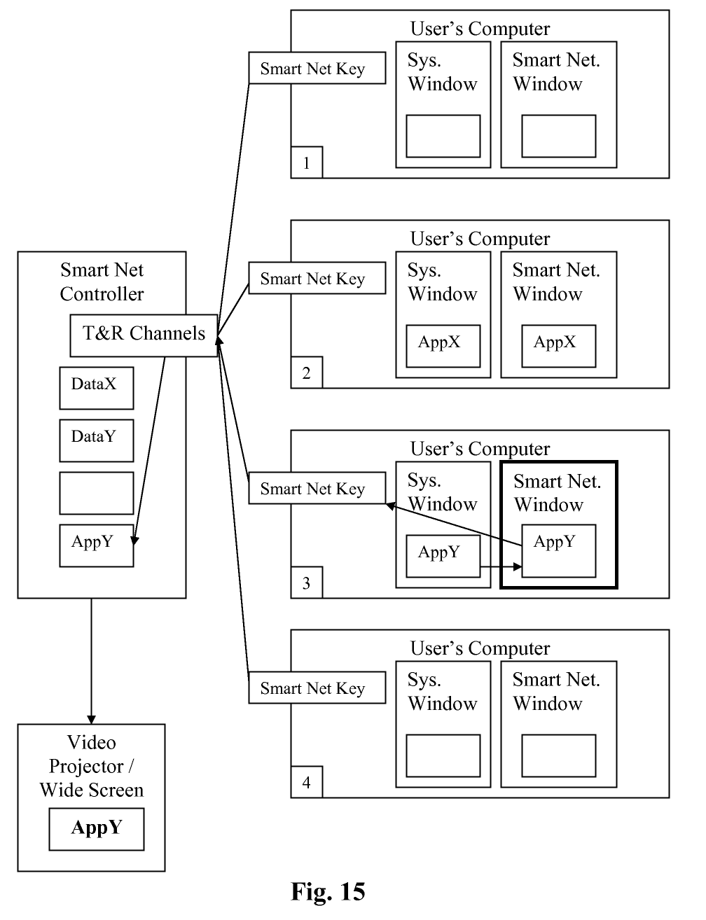

In FIG. 15 a chain of events, similar to those of FIG. 13 takes place. The result is that AppY is now displayed on the video projector as the user of computer 3 delivers a presentation. Note in FIG. 15 that a video cable did not need to change from computer 2 to computer 3. Unlike a common computer shared by all the presenters, the user of computer 3 has a presentation ready to go the moment control of the video projector passed to computer 3. Unlike some presentation situations, the presenters did not need to change chairs or “the driver's seat” in order to gain access to a common computer.

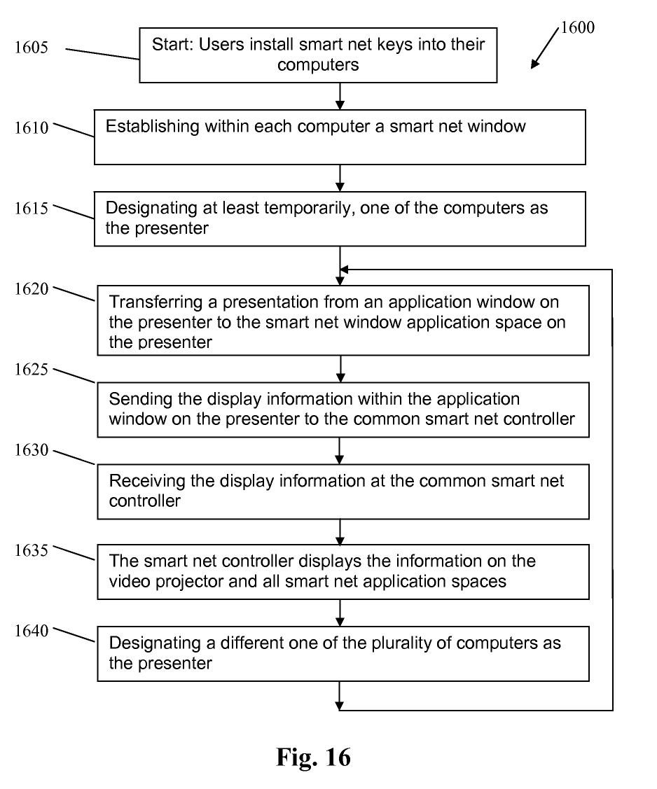

FIG. 16 summarizes the events typical of the smart net system in flow chart 1600. At 1605 each user installs a smart net key into their computer. Block 1610 establishes a smart net window in each computer by way of the software on the smart net key or the smart net controller. Block 1615 designates one of the computers as the presenter giving that computer control of the video projector. At 1620 the presenter transfers a presentation from an application window to the smart net window application space. At 1625 the smart net system sends the display information from the presenter's smart net window application space to the smart net controller via the smart net key and the T&R channels of the smart net controller. At 1630 the smart net controller receives the display information sent from the presenter's computer and at 1135 the smart net controller displays information on the video projector and all smart net application spaces. At 1640 the users themselves or a moderator can designate another presenter. The loop from block 1640 to block 1620 illustrates that multiple users can share access to the video projector as the meeting, conference or class progresses.

### Advantages

Time is saved with the smart net system as users do not need to switch cables or chairs during a conference, class or meeting.

By its inherent nature the smart net system is completely isolates all computers from each other while allowing them to exchange information.

Risk of damage due to ESD or damages connector pins is reduces because users do not need to constantly connect and reconnect cables or devices.

Users do not need to send their data and presentations ahead of a meeting. This reduces the lead time for presentations and handouts.

Users do not need to share a common display computer and can avoid many software compatibility issues.

Problems associated with connecting to a common network such as configuration and security are reduced.

The smart net system is flexible allowing users themselves or a designated moderator to control access to the video projector.

Paper handouts are eliminated as data can be made available to each user.

The smart net system reduces the inconvenience of trying to email presentations and data after a conference because both can be made available to all users in real time.

The internet/network port on the smart net controller allows for remote users to be part of the smart net system by the addition of a remote smart net controller connected to the internet or phone system.

An audio port on the smart net key and smart net controller enables question and answer sessions in large forums such as lecture halls. No longer does a person need to shout down to the podium or wait for a microphone to make its way up from the podium. The smart net controller's audio output port can connect to a lecture hall public address system.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention.

### CLAIM PROLOGUE

Insure to read the terminology, definitions and clarifications portion of the Description section of the patent application prior to reviewing the claims section. Due to the uniqueness of this technology some terms were invented and other terms without being used in their proper context could create misinterpretation in the claims.

1. A computing apparatus called the smart net computer comprising of, its own internal computer circuitry, memory storage circuitry, graphics user interface referred to as the smart window, its own computer operating system, firmware, protocols, profiles and configurations, its own computer isolation networking circuitry, interfaces, software, firmware, protocols, profiles and configurations referred to as the smart network, its own security system, software, firmware and protocols, its own wire or wireless i/o system including the smart key for communication between one or more connected computers and the said smart net computer, the said smart net computer generates the said smart window as it connects to each said connected computer which is visible on the said connected computer and its associated viewing apparatus, the said smart window provides both a visual viewport into the said smart net computer and acts as a gateway between the said connected computers and said smart net computer for transferring data in one or more directions utilizing a combination of the said smart window graphics user interface functions, the said smart net computer circuitry and the said interface circuitry, to provide interaction between one or more combinations of said connected computers, connected computing devices and said smart net computer.

2. A computing apparatus called the smart net computer comprising of, its own computer, memory storage, graphics user interface referred to as the smart window, smart net computer operating system, protocols, profiles, configurations, security, internet profile, external electronic device communications, self contained computer network with or without the ability for independent isolation, that can communicate using wire or wireless i/o systems to one or more connected computers where each said connected computer has the said smart window initiated from the said smart net computer to the said connected computer and its associated viewing apparatus, the said smart window becomes a common or parallel window shared across one of more said connected computers and its associated viewing apparatus providing the viewport and gateway between the said connected computer and the said smart net computer for the transfer of data between any of the said connected computers and the said smart net computer or between the said smart net computer and the said connected computers, the said smart net computer isolates each said connected computer from one another but allows the smart window with the smart net computer to act as an independent isolated network for sharing data between said connected computers without actually establishing a traditional network connection between computers thereby preventing unwanted communication between said connected computers but allowing for the sharing of information across the smart network.

3. A computing apparatus called the smart net computer comprising of its own computer, memory storage, graphics user interface, referred to as the smart window, smart net computer operating system, protocols, profiles, configurations, security, internet profile, external electronic device communications, self contained computer network with or without the ability for independent isolation, that can communicate using wire or wireless i/o systems to one or more computers where multiple other electronic devices like an video projector, external computer network, telecommunications connections or other communication devices may be connected to the smart net computer, each connected computer can control a device within the smart window, in one embodiment a conference room with a number of persons each having laptop computers plug a smart key into their said laptop computer, the resulting said smart window appears on each said connected computer and its associated viewing apparatus, one of the said connected computers can run a presentation and place it into the smart net application space where the presentation is seen on the connected video projector, at the same time the said smart window is still able to share data between said connected computers, this same concept can be used in multiple applications like the classroom or gaming environment, adaptations of the said smart net can be as simple as a box sitting on the conference room table to the more complex concept of a gaming card with multiple communication ports that plugs directly into a gaming computer connecting to multiple computers utilizing smart key or other methods of connectivity.

4. The smart net computer of claim 1 further comprises of a long term fixed or removable, scalable memory storage for the long term storage and retrieval of data in the smart net computer, some embodiments of the said long term fixed or removable memory storage for example nand flash memory or a hard drive, in some embodiments the removable memory card provides the additional flexibility of changing software and software licenses by simply replacing the memory card in the smart net computer.

5. The smart net computer of claim 1 further comprises of a long term fixed or removable or scalable memory storage for the permanent storage and retrieval of data in the smart net computing device, short term fixed or removable or scalable memory storage and retrieval of data in the said smart net computing device, some examples of the said long term fixed or removable memory storage would be nand flash memory or a hard drive, some examples of the said short term fixed or removable memory storage like dram memory, examples of the said short term memory applications range from running programs remotely from said connected computers to viewing data on said connected computers within the application space of the said smart net computing device.

6. The smart net computer of claim 1 comprises of comprises of its own internal computer circuitry, software and firmware that can create, modify, store, one or more profiles, internet profiles, security profiles, software configurations, hardware profiles, hardware configurations for use on connected computers or computing devices connected to the said smart net computer or use on the said connected computers or said computing devices.

7. The smart net computing device of claim 1 further comprises of a smart key that utilizes an i/o systems to connect multiple computers to the smart net computer, multiple methods of communicating between the said smart net computer and connected computers are possible, the smart key concept is convenient for environments such as conference rooms or classrooms where the said smart net can permanently reside and connect to one or more communication devices like an video projector, multiple said smart keys can be stored with the said smart net computing device for use while in the conference room by simply plugging the said smart key into your computing device, for example a laptop computer, notebook computer or other computing device, the smart key connects the said computing device to the smart net computing device and the smart window is created within the said connected computer and its associated view screen, the said smart key can be returned to the said smart net computing device upon the completion of the conference for later use in some applications, the said smart key can be kept with the connected computer for other applications of the said smart net computing device.

8. The smart net computer of claim 1 further comprises of a computing device that provides connections to one or more electronics devices including but not limited to video projector technology, video technology, wire or wireless i/o computer networks, telecommunications devices, audio devices including voice recognition, bio-metric security devices, in some embodiments the use model is the said video projector as it connects to the said smart net computing device, the connected computer in control of the application space of the smart window is used to connect the said video projector to the said connected computer providing access to the said video projector within the said smart window, in another embodiment of the use model is the said computer network as it connects to the said smart net computing device, the said connected computer in control of the application space of the said smart window is used to connect the said computer network to the said connected computer providing access to the said computer network from the said smart window.

9. The smart net computer of claim 1 further comprises of, but is not limited to and may utilize various configurations of a computing device that provides electronic isolation between the connected computer and the connected electronics device, the said connected computer and other said connected computers, the said connected electronics device and the said connected computer, the smart net computing device may act as an electronic isolation barrier for said connected computers preventing access to the said connected computers, by virtue of the smart window, by preventing access between said connected computers but allowing said connected computers to transfer data to the said smart net computing device by way of said smart window, by preventing access between said connected computers and said electronic devices but allowing said connected computers to transfer data to the said electronics devices by way of said smart window, by preventing access between said electronic devices and said connected computers but allowing said electronic devices to transfer data to the said connected computers by way of said smart window, said connected computers are protected from one another but still provide data transfer of desired information placed into the said smart net computing device accessible only by way of the said smart window.

10. The smart net computer of claim 2 further comprises of circuitry, software and firmware that allow the smart net computer to function as a smart net computer network between the said smart net computer and computers connected to the said smart net computer, this smart net computer network is referred to as the smart network, in some embodiments of the said smart network the computers connected to the smart net computer can transfer data using one or more methods of the smart window graphic user interface between said computers or between said computers and the said smart net computer, or any other said computer connected to other computer networks.

11. The smart net computer of claim 2 further comprises of, a classroom communications device that may be utilized as a method to connect multiple computers to the smart net computer, multiple methods of communicating between the said smart net computing device and connected computers are possible, in one embodiment the smart key concept is convenient for environments such as classrooms where the said smart net computer can permanently reside, the said smart key can be programmable to communicate with multiple smart net computing devices that may reside in different locations like separate classrooms where independent communication channels is desirable or a method for accessing specific classroom said smart net computers, one example of this classroom specific identification may be a programmable device within the said smart key that contains coded access to allow the said smart key to function in different locations like separate classrooms, the coded access can be renewable over a website or utilize other methods for electronically updating or changing the said independent communications channels as the location of specific said smart net computer requires, the coded access can be programmed to expire at a certain time to be used as a renewable resource for connecting to the various said smart net computers.

12. The smart net computing device of claim 2 further comprises of, a smart key that may be utilized as a method to connect multiple computers to the smart net computer, multiple methods of communicating between the said smart net computer and connected computers are possible, the smart key concept is convenient for environments such as the small office where computers reside in proximity of the smart net computer, multiple said smart keys can be utilized by simply plugging the said smart key into the said connected computer or computing device within the said small office environment to allow the sharing of a smart window across groups of said connected computers for communication via the smart network without using a traditional router or network to communicate between said connected computers, the advantages of this kind of communication provide a method of communicating between said connected computers in a more secure fashion as said smart network allows for the sharing of information between said connected computers via the said smart window without providing access between said connected computers and their associated stored information.

13. The smart net computer of claim 2 further comprises of a isolated computer network, called the smart network, to connect computers in proximity with each other using a common graphics user interface called the smart net window, in some embodiments the smart network can connect to other traditional computer networks to allow smart net computer users access to network data while preventing other network computers from accessing the smart net computer or any of its connected computers, military use of the said smart net computer is a great example of this type of application, individual computer users in proximity of the smart net computer can connect to the smart net and access data from other computer networks while remaining unconnected from the other computer networks providing additional levels of security control for highly confidential material access and control to information.

14. The smart net computer of claim 2 further comprises of an isolated computer network, called the smart network, to connect computers in proximity with each other using a common graphics user interface called the smart net window, in some embodiments the smart network can connect only to the computer group it is assigned to for example a small office environment where users are in proximity of each other the smart network is used to communicate between connected computers with chat or instant messaging without requiring the smart network computer group to connect to a network providing additional levels of security control as smart net computer traffic is isolated.

15. The smart net computer of claim 2 further comprises of a graphics user interface called a smart net window that is a viewport into the data stored on the smart net computer and a gateway to transfer data between one or more connected computers and the said smart net computer or between one or more said connected computers and computer networks connected to the smart net computer when defined, in some embodiments the said smart window as it appears on each additional said connected computer and is a parallel viewport and parallel gateway between one or more of the said connected computers and its associated view screen, said data can be transferred between said connected computers and the said smart net computer or between said connected computers and other connected electronics devices.

16. The smart net computer of claim 3 further comprises of one or more i/o systems as a method to connect the said smart net computer and connected computers, in some embodiments the smart key would communicate between the said connected computer usb port and the said smart net computer using the usb interface between the said connected computer and the inserted said smart key and an electronic interface like wi-fi between the said smart key and the said smart net computer, in some embodiments an electronic interface like wi-fi between the said smart net computer and the said connected computer without the said smart key, in some embodiments multiple combinations of wireless i/o system standards with or without the said smart key are possible to establish communications between the said smart net computer, said connected computers or other computing devices, the smart key concept is convenient for environments such as conference rooms or classrooms where the said smart keys can communicate with said smart net computer which connects to one or more computing, audio or video devices such as an video projector, multiple said smart keys can be stored with the said smart net computer for use while in the conference room or classroom by simply plugging the said smart key into the said connected computer, the smart key connects the said connected computer to the said smart net computer and the said smart window is created within the said connected computer and its associated view screen, the said smart key can be returned to the said smart net computer upon the completion of the conference for later use in one of its many use models.

17. The smart net computer of claim 3 further comprises, of one or more i/o systems to connect the smart key, the said smart net computer and one or more computers or computing devices, in some embodiments the smart key itself can be used to communicate between connected computers and the said smart net computer utilizing one or more wire or wireless i/o system methods thereby creating the smart net computing network between said computers and said smart net computer.

18. The smart key communication device of claim 3 further comprises of a programmable smart key that communicates with multiple smart net computing devices that may reside in different locations, one embodiment of this in a classroom environment where separate classrooms requiring independent communication channels or a method for accessing from specific classrooms to said smart net computing devices, one embodiment of this classroom specific identification may be a programmable device within the said smart key that contains coded access to allow the said smart key to function in said different locations like separate classrooms, one embodiment of the coded access can be renewable over a website or utilize other methods for electronically updating or changing the said independent communications channels as the location of specific said smart net computers require, the coded access can be programmed to expire at a certain time to be used as a renewable resource for connecting to the various said smart net computers as class or semesters change.

19. The smart net computer of claim 3 comprises of circuitry with audio communication capabilities between the smart net computer user and the smart net computer, said audio communication capabilities are used for multiple features within the said smart net computer, in one embodiment the audio input can be used for voiceprint recognition to access the said smart net computer for potential security control, in another embodiment the audio input can be saved as an audio file on the said smart net computer for later recovery, in another embodiment the audio input can be converted to a text file stored within the said smart net computer for later recovery, audio conversion to text requires very little memory storage space and is a convenient way for one to use the smart net computer as an event or personal storage device, the audio conversion programs can be accessed from the said smart net computer and run on the said smart net computer without connecting to any other computing device, any or all combinations of audio record and playback utilizing any or all combinations of internal or external transducer or transceiver input or output are potentially possible, use examples range from recording important meeting to transcribing meeting notes from the original audio content for documentation.

20. The smart net computer of claim 3 further comprises of, a multi channel i/o system communications device that may be utilized as a method to connect multiple computers to the smart net, multiple methods of communicating between the said smart net computing device and connected computers are possible, the smart key is illustrated as one embodiment, another more adaptive embodiment for use in a gaming or classroom environment is a multi channel communications device that plugs directly into a gaming computer or into the teachers classroom computer, said multi channel i/o systems communications device, using one of several i/o communication methods, would communicate between the said gaming computer and gaming player computing devices or between the said classroom computer and student computing devices, in some embodiments the classroom communications can be used for student testing, homework distribution and general classroom interaction and data sharing.

21. The smart net computer of claim 3 further comprises of its own computer and computer operating system with a smart net graphics user interface, referred to as the smart window, in some embodiments the said smart window is divided up into areas of multiple use including an application space, data space, file transfer space, telecommunications space, network space, chat space, instant message space along with the ability to select the owner of some spaces for an effective master user control of select spaces for instance it is desirable for one smart net user at a time to control the application viewing space for controlling the video projector, while copying or sharing data is wide open to all connected computers in a simultaneous manner, the said smart window is a parallel window across multiple connected computers, each said connected computer maintains control of its own functionality and each said connected computers is isolated from one another yet maintain the capability of interactive control of said spaces and interactive control of said data between the said smart window and the said connected computers.

22. The smart net computer of claim 3 comprises of computer security controls inside the smart net computer that in some embodiments contains, computer circuitry, software and firmware security protocols to prevent unauthorized access of data located on the said smart net computer in case of theft, the smart net computer has password protection combined with prior connected computer host ID recording, most computers have an identity called a host id, this host id is unique and is recorded within the smart net computer with each computer the smart net computer connects to, unrecorded host id computers require entering the said smart net password effectively blocking the access to information on the smart net computer, the said smart net may provide bio-metric safeguards like a thumbprint reader or voice print identification for higher levels of security control.

23. The smart net computer of claim 3 further comprises of a one or more electronic interfaces as a method to connect the said smart net computer to other computing or electronics devices, in one embodiment the said smart net computer connects to a video projector, a keyboard and a computer mouse, this configuration provides the smart net computer user the ability to utilize the capabilities of the video projector to serve as the video apparatus for the smart net computer with traditional user interface devices, a keyboard and a mouse to provide human interaction, in some embodiments the smart net computer with other interfaces like telecommunications, audio, or traditional network connectivity can access these electronic devices in the same manner previously described providing many additional options to the smart net computer network users.
